(19) United States
(12) Patent Application Publication
(10) Pub. No.: US 2008/0178105 A1
(43) Pub. Date: Jul. 24, 2008

(54) SYSTEM AND METHOD FOR PLANNING STUDENT ASSIGNMENTS

(76) Inventor: Joshua Loewenstein, Belmont, MA (US)

Correspondence Address: WOLF GREENFIELD & SACKS, P.C., 600 ATLANTIC AVENUE, BOSTON, MA, 02210-2206, US

(21) Appl. No.: 12/018,494

(22) Filed: Jan. 23, 2008

Related U.S. Application Data
(60) Provisional application No. 60/886,173, filed on Jan. 23, 2007.
(60) Provisional application No. 60/928,612, filed on May 10, 2007.

(51) Int. Cl. G06F 3/048

(52) U.S. Cl. 715/764

(57) ABSTRACT

A system for aiding a student define, plan and/or execute tasks related to homework. The system provides user interfaces that guide the student through processes of defining tasks, scheduling work time to complete tasks and tracking progress against completing the tasks. The system may plan time for completing tasks during the scheduled work time and may update the plan as tasks change, work time changes or estimates of time require to complete each task are updated based on progress information. The system may also aid the user in executing the tasks by sending notifications to the user of planned start times for work on tasks and by automatically blocking distractions during work times.

### FIELD OF THE INVENTION

The invention relates generally to tools to assist students schedule and perform study-related tasks.

### BACKGROUND OF THE INVENTION

While intelligence and hard work are necessary for academic success, they are not sufficient to bring it about. Other attributes, such as the capacity to plan and follow through with academic work are also crucial. The challenge becomes especially pronounced as students progress academically, and are expected, with increasing independence, to tackle more open ended and complex assignments.

Furthermore, students today work in a “natural habitat” more complex than that of previous generations, because of the online universe of games, internet content, and communication and social networking applications available at their fingertips. As with watching television and talking on the phone 10 or 20 years ago, the question is not whether adolescents will or won't participate, but, rather, how they will regulate their participation.

### SUMMARY OF THE INVENTION

In one aspect, the invention relates to a system to aid students define, schedule and/or execute tasks. The system receives inputs from a user scheduling work time and identifying tasks to be completed. The system may then plan time for executing tasks, considering the scheduled work time and characteristics of the tasks, such as, for example, due date, priority and time required for completion. Additionally, in some embodiments, the system may plan execution of tasks based on user-specified parameters. For example, a user may specify the maximum or minimum block of time during which a single task should be planned for execution. The planning system may be adaptive, altering the plan for execution of tasks based on changed conditions, including changes in scheduled study time, changes in tasks, progress towards completion of tasks and changes in estimated completion times for tasks.

Accordingly, the invention may be embodied in a computer-readable medium having a plurality of computer-executable components. Those components may include a task list component for obtaining from a user information relating to a task, such as a task due date; a user interface component for obtaining from a user an indication of available work time; a planning component for automatically planning work on the task during the available work time; and a reminder component for providing a cue to the user of the planned available work time for the task.

The invention may also be embodied as a method of scheduling tasks. The method may include receiving user input defining available work time, tasks and estimated work time for each task. A plan for work on the tasks within the available work time may then be received, which may then be presented in a calendar.

The system may provide user interfaces to guide a user through defining, planning and/or executing tasks. To aid in defining tasks, the system may provide one or more interfaces through which a user may input task descriptions. For example, a user may use such interfaces to input information on assignments. One or more interfaces may be provided to allow the user to define subsections of assignments that may be more readily planned and performed.

The system may aid in planning tasks by providing information on amounts of work time that need to be scheduled to allow execution of all defined tasks. The information on the amount of additional work time required may be presented in any suitable way, but in some embodiments is presented in one or more fields displayed in conjunction with a calendar through which a user may schedule work time and/or view due dates associated with tasks. The system may present multiple calendar views, each showing a different interval of time, such as a week or a month. In some embodiments, a field displaying additional work time required may display work time required for scheduling during the interval displayed.

To aid a user with planning tasks, the user may present one or more interfaces through which a user may view a proposed plan computed by the system. Such interfaces may allow the user to accept or modify the plan.

To aid a user with executing tasks, the system may provide notifications to the user at times when the user should take action. For example, notifications may be sent to indicate the planned start time of a task. Notifications may be sent in any suitable form, such as via e-mail or SMS messages.

To further aid the user with executing tasks, the system may conditionally block operations that may create a distraction for the user. Distractions may be blocked during intervals in which tasks are planned for execution or during scheduled work times, or at any during any other suitable interval. Any activity that may act as a distractor may be conditionally blocked. Operations of the system itself unrelated to the execution of tasks may be blocked. Alternatively or additionally, execution of programs, such as games, on a user's computer or access to Internet web sites may be blocked. These actions may be conditionally blocked based on subject area. For example, it may be desirable to block execution of game programs but not to block execution of a word processing program that is used to complete assignments. Accordingly, in some embodiments, the system may include a component installed on the user's computer that can conditionally bock execution of programs, access to Internet web sites or other distracting activities. The component may be configurable for conditional blocking based on time and/or subject matter of the activity blocked.

The invention may also be embodied as a computer-implemented method of improving student homework assignment planning and follow through. As part of the method, one or more tasks to be completed by a user may be identified. Work time may then be scheduled and access to software or hardware may be blocked during scheduled work time.

Interfaces that allow definition of information may also be used to edit or delete previously defined information. Also, fields through which the system provides information may be updated as tasks are defined, completed or executed, work time is scheduled or other changes in operating state of the system occur. The updates may be automatic or may be performed in response to user input.

In one aspect, the invention may be embodied as a method that includes listing tasks that need to be accomplished, scheduling the tasks to be completed, reminding the user of the scheduled tasks to be completed and blocking activities not related to completing the task during the scheduled time for completing the tasks. The method may be implemented in a computer environment. In some embodiments, the method is implemented in a web based software application including a task list component, a scheduling component, a reminder component, and a blocking component. By using the present method, a student can improve their ability to successfully complete complex tasks, thereby improving academic performance while decreasing effort and stress.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a student assignment planning system according to embodiments of the invention;

FIG. 2 is a block diagram illustrating a software architecture of the system of FIG. 2;

FIG. 3 is a sketch of a graphical user interface through which a user may input information relating to an assignment according to some embodiments of the invention;

FIG. 4 is a sketch of a second graphical user interface through which a user may input information relating to an assignment according to some embodiments of the invention;

FIG. 5 is a sketch of a third graphical user interface through which a user may input information relating to an assignment according to some embodiments of the invention;

FIG. 6 is a sketch of a fourth graphical user interface through which a user may input information relating to an assignment according to some embodiments of the invention;

FIG. 7 is a sketch of a user interface presenting to a user information about planned assignments according to some embodiments of the invention;

FIG. 8 is a sketch of an alternative embodiment of a user interface presenting a user with information relating to planned assignments according to some embodiments of the invention;

FIG. 9 is a sketch of a graphical user interface through which a user may schedule study time according to some embodiments of the invention;

FIG. 10 is a sketch of a user interface through which a user may update progress towards completing assignments according to some embodiments of the invention;

FIG. 11 is a sketch of a graphical user interface enabling restricted collaboration among users of a system for planning student assignments according to some embodiments of the invention;

FIG. 12 is a sketch of a graphical user interface to a system for planning student assignments according to some embodiments of the invention; and

FIG. 13 is a sketch of a user interface through which information on planned assignments is presented to a user according to an alternative embodiment of the invention.

### DETAILED DESCRIPTION

The inventor has appreciated that student performance is often hampered by an inability to effectively break large study tasks into smaller ones, develop a timeline for completing study tasks, actually initiate studying at the appropriate times, and manage distractions in order to stay on task. These challenges often appear as difficulty completing homework assignments. Consequently, students are frequently hampered by poor planning, procrastination, and distractions.

The inventor has also appreciated that a computer implemented system may be constructed to aid students schedule and perform assignments. Such a system may present information and choices to the student in a format and at times that will aid the student perform those assignments. Additionally, such a system may preclude the student from being exposed to distractions that could interfere with the timely completion of assignments.

In some embodiments, a scheduling system may implemented as a collection of interacting computer-executable components. The components may include:
1) A task entry component, adapted to perform functions related to entry by a user of new tasks.
2) A task updating component, adapted to perform functions related to updating existing tasks, such as to indicate progress towards completing the task, or altering the time necessary to complete the task.
3) A calendar component, adapted to present multiple calendar views to a user and receive input identifying events, which may be as known in the art of calendaring programs. Additionally, the calendar component may be adapted to receive input by which blocks of time are designated for the completion of one or more types of tasks (i.e. blocks of work time, which in an embodiment in which the scheduling systems is used by a student, may be blocks of study time)
4) A planning component, adapted to prepare a plan in which tasks are planned for certain times. The planning component may support a user interface through which a user may accept or modify the plan prepared by the planning proposal. In embodiments in which the scheduling system is used to schedule school related assignments, the planning component may produce a proposal of a study schedule, or work schedule, in which tasks are placed in blocks of designated study time or work time. The planning component may interface with the calendar component, allowing the calendar component to present the schedule in a calendar view.
5) A notification component, adapted to notify a user about the time to begin working on specific tasks, for example notification via SMS message
6) A blocking component, adapted to conditionally block distractions, such as software applications, games, and/or online content (e.g. YouTube) under certain conditions, for example during time when study or work tasks are scheduled.

A scheduling system according to embodiments of the invention may be adapted for use by a student. In such an embodiment, the task component may perform processes such as:
Categorization of tasks (e.g. “English”, “Math”, “Science”, or “Trade Shows”, “White Papers”, “Copywriting”)
Manipulation of multilevel tasks, such as—top level: “English Paper” and—second level: “reading,” “outlining,” “rough draft” and “final draft”
Associating parameters with tasks—for example, category, type, description, start date, due date, duration, priority, and time left to complete
   The task updating component may perform functions such as:
Indicating to a user that tasks or subtasks have been completed
Indicating to a user that less time remains to complete an existing task or subtask, presumably because of time spent by the user working on it
Indicating to a user that a task or subtask is expected to require more time to complete than originally anticipated
   The calendar component may perform functions such as:
Presenting multiple calendar views, which may include day, week, and month views
Receiving input defining “typical” calendar events, such as “team meeting at noon on Tuesday”.
Receiving input defining one or more types of blocks of time, with each dedicated to the completion of a specific type of work, but not, initially, a specific work task or subtask. Examples include “study time”, and “time dedicated to work on client A's project”
   The planning component may perform functions such as:
In response to user input, preparing a proposed plan for when to work on each task and subtask entered by the user, with the time to work on the tasks and subtasks scheduled into the appropriate type of block. For example, academic assignments are scheduled into blocks of “study time,” and tasks associated with work for client A are scheduled in blocks of time set aside for client A.
In response to user input, preparing a new proposed plan that accounts for new user input, such as the entry of new tasks or subtasks, making progress on or completing existing tasks, and changes to the blocks of time set aside for the completion of tasks.
   The notification component may perform functions such as:
Sending notifications to the user to indicate that a calendar event of any kind will occur, or will end, in a fixed amount of time. For example, a user may choose to be notified 5 minutes prior to any scheduled study task.
Sending notifications by various channels as selected by the user, for example, sending notifications by email, and/or by SMS message.
Notifying multiple recipients of events
   The blocking component may perform functions, such as:
Blocking of computer related activities that could distract the user from completing a scheduled task, with such activities including playing a computer game, using chat software, or accessing specific websites that may distract the user.
Blocking contingent on certain conditions, if so chosen by the user, for example, the blocking may occur only when a work or study task is scheduled, or only when a block of work time or study time is scheduled, whether or not a study or work task has been scheduled within it.

These components may be implemented in any suitable computer system. In some embodiments, the system may be implemented as a web service. The web service may maintain data relating to each of a plurality of users that may subscribe to the web service. Information about each of the users may be maintained in a separate account for each user. The web service may associate with each user information about that user's tasks, plans, progress against task, preferences, contact information or other information necessary or desirable for implementing a scheduling web service. Such a web service may support multiple subscribers simultaneously. However, for simplicity of illustration, interaction with a single subscriber is shown.

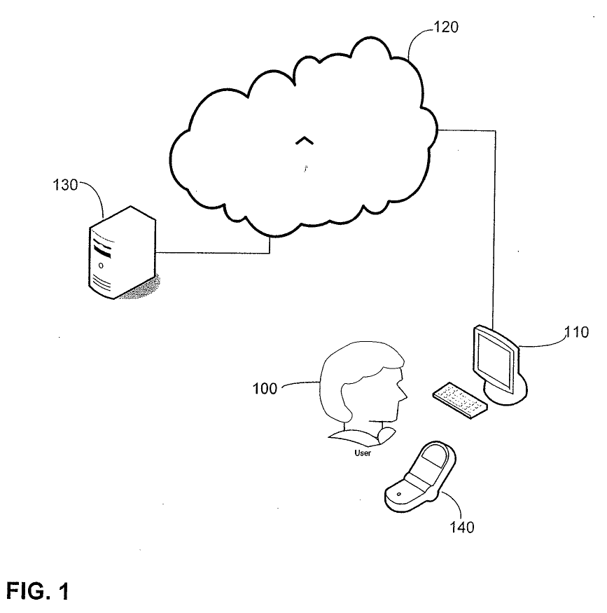

Such a computer implemented system may be implemented in a computing environment as illustrated in FIG. 1. In the computing environment of FIG. 1, a user 100 interacts with the system through a user computer 110. In the embodiment illustrated, user computer 110 is connected to a network 120, which may be the Internet. Through network 120, user computer 110 may access a server 130. Computer software components adapted to implement portions of the invention may be executed on either or both of server 130 and user computer 110. However, components of the invention may be implemented in any suitable way.

In the embodiment illustrated, the task entry component, the task updating component, the calendar component, the planning component and the notification component may execute on server 130. The blocking component may execute on user computer 110 or it may have subcomponents that execute on both server 130 and user computer 110. However, the specific implementation of each of the components is not a limitation on the invention and the components may be implemented in any suitable way.

In the embodiment of FIG. 1, user 100 may have access to an electronic device for receiving or sending communications relating to the task scheduling system. The device may be portable such that user 100 may receive information about tasks or provide information even when user 100 does not have access to user computer 110. In the embodiment illustrated, one such portable electronic device is illustrated as cell phone 140. Cell phone 140, for example, may be used by user 100 to receive electronic communications, such as a phone call, an SMS message an e-mail or other transmission. Alternatively or additionally, a user may use a portable electronic device to provide input to the system, such as input defining study time or a task to be scheduled. As a specific example, a text message identifying a new task and a due date may be sent from a student to a number used by the system. The system may associate the text message with the user and record a new task for that user.

In operation, user 100 may interact with the components of the scheduling system to perform processes related to the definition, planning or execution of tasks. User 100 may input information to the scheduling system through user computer 110 or in any other suitable way. User 100 may also input information about times the user has available for completing tasks. In the embodiment described, the scheduling system is used by a student planning tasks related to school assignments during available study times, but the scheduling system may be applied in other contexts. The scheduling system, as it executes on server 130, may guide user 100 through a process of planning tasks necessary to complete the assignments in the available study time. Additionally, the assignment scheduling system may provide notifications to user 100, indicating times at which user 100 should perform tasks associated with completing the assignments.

As user 100 progresses on completing the tasks, user 100 may provide progress information, which server 130 may be configured to use to suggest an updated plan for completing defined tasks to user 100. In this way, user 100 may interact with the scheduling system to plan tasks, track performance against previously planned tasks and to update the plan, as necessary.

In addition, the system may aid user 100 in completing tasks according to the plan by providing notifications to user 100. The scheduling system also may aid user 100 in completing tasks according to the plan by blocking distractions for user 100 during scheduled work times. For example, the system may include components that block operation of electronic devices or certain functions of electronic devices deemed to be distractors during scheduled study intervals.

To support such a blocking function, a blocking component on user computer 110 may conditionally block access to specified websites or programs, such as games, executing on user computer 110 during schedule study intervals. However, the blocking components contemplated by the invention are not limited to components that block functions of user computer 110. For example, blocking components may be integrated into set top boxes that control the display of television signals or into cellular telephones or other electronic devices with which the scheduling system may communicate.

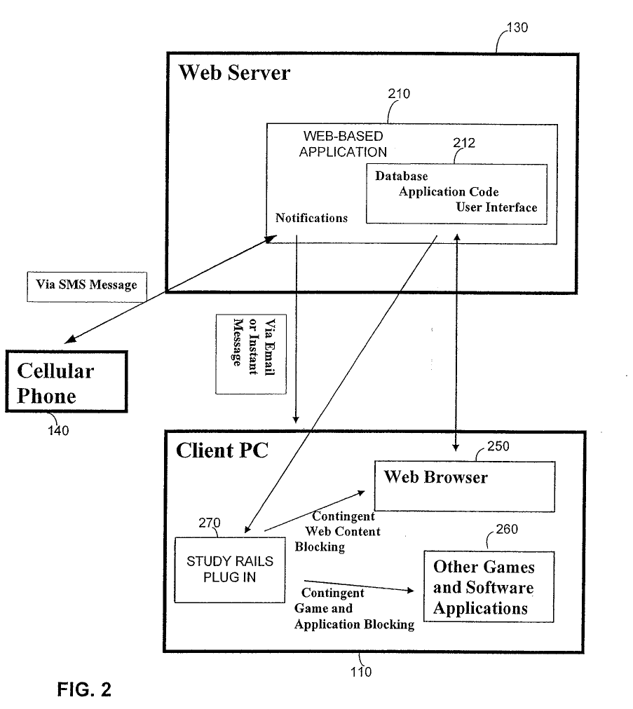

Turning to FIG. 2, an architectural block diagram of a scheduling system according to an embodiment of the invention is shown. In the example illustrated, the scheduling system includes a web based application 210 installed on web server 130. Web based application 210 may be implemented using technology as known in the art for implementing a web based application. Web based application 210 may encompass one or more components that comprise the scheduling system, such as a task entry component, a task updating component, a calendar component, a planning component and a notification component. However, the specific components incorporated in a web-based application are not critical to the invention and web based application 210 may contain different or additional components.

Additionally, one or more components that support operation of the components of the web based application 210 may be included on server 130. For example, a user interface component configured to exchange information with user 100 may be present. In the embodiment illustrated, the user interface component presents information to a user by transmitting information to client computer 110 where the information may then be displayed for the user.

In the embodiment illustrated, client computer 110 is configured with a web browser program 250. Web browser 250 may be a web browser as is known in the art or implemented in any other way as a client component for displaying information from web based application 210. In the embodiment in which client computer 110 includes a web browser 250, the user interface component on server 130 may format information for display in an HTML format or in any other suitable format.

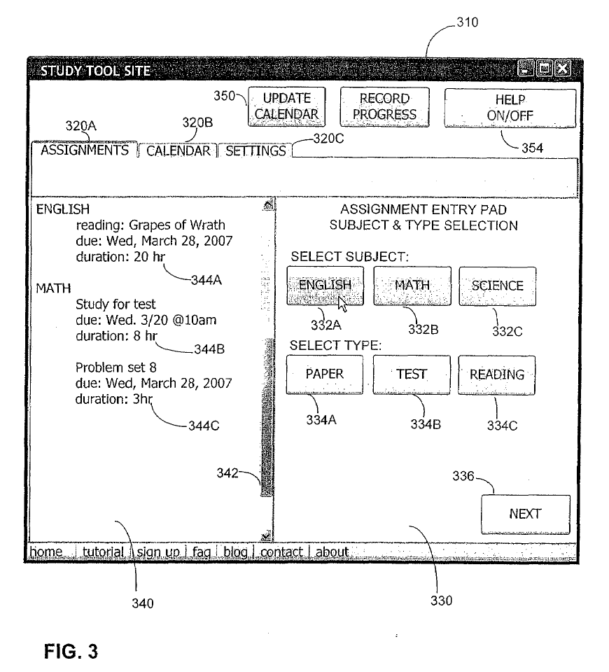

The information displayed through web browser 250 may also specify one or more input areas or control objects to define a graphical user interface through which user 100 may interact with the scheduling system. Through the input areas, a user may provide information for processing by the web based application. Specific examples of the nature and format of information that may be presented to a user or received from a user are described in FIGS. 3-11, below. However, the specific information exchanged with a user is not a limitation on the invention and any information unnecessary or desirable for operation of web based application 210 may be exchanged with the user.

Web based application 210 also may include a database component. The database component may store information used in the operation of the scheduling system. For example, users of the scheduling system may have accounts. Information on each account may be stored in a data base associated with web server 130 by the data base component. Each user may input information relating to available study time, assignments to be performed or other information used by the scheduling system. Database component within web based application 210 may store and retrieve this information from a database in a way that information relating to each user is accessed for performing functions for that user.

FIG. 2 also indicates that web based application 210 includes a notification component that sends notifications to a user. For example, web based application 210 may send a notification to a user at the start of scheduled study time for that user, indicating specific tasks to be performed in that time period. Additionally, notifications may indicate the end of study time or a time during a study interval during which a user should switch to a different task. The notifications may be sent to a user in any suitable way. In the embodiment illustrated in FIG. 1 and FIG. 2, a user has a cellular phone 140. Accordingly, web server 130 may interface to an SMS messaging system, such as may be provided by a cellular telephone company. In such an embodiment, the notification component of web based application 210 may include an interface to an SMS messaging system to cause SMS messages (text messages) to be sent to a user at desired times. However, other communication media may be used for communicating notifications and web based application 210 may include interfaces to other communication systems. For example, notifications may be sent to a user via email or instant messages. Accordingly, the notification component of web based application 210 may interface with an email or instant messaging system for communicating notifications to a user.

Further, web based application 210 may include an application component. The application component may be encoded to control the overall operation of the web based application 210. For example, the application component may process user input identifying available study time and assignments, and control a process of receiving user input defining tasks necessary for completion of the assignments. The application component may further control execution of processes that results in assignment of specific tasks to specific blocks of studied time. Further, the application component may store this information using the data base component in such a way that the notification component may identify times at which notifications are required. In this way, the components of web based application 220 may interact to perform functions associated with the scheduling an execution of assignments.

In the embodiment illustrated, interactions with user 100 are predominantly through user computer 110. As described above, user computer 110 includes a web browser 250 for presenting a user interface for the scheduling system to a user. In some embodiments, no specific client based components of the scheduling system are necessary on client computer 110. However, it may be desirable in some embodiments to include components of the scheduling system on user computer 110. In the example illustrated, the scheduling system includes a blocking component 270 installed on user computer 110.

The blocking component of the application helps the user to better manage potential distractions to completing tasks. During designated blocks of work time, the component blocks access to non-essential software and/or hardware on the computer being used to complete the task, such as music players, instant messaging software, email software, and web browsers. Indeed, partial blocking may also be implemented, such as to block non-essential websites, like social networking or video websites, while pertinent websites remain accessible. These kinds of software and hardware often provide highly stimulating content. The blocking component may also facilitate completion of tasks by blocking distractions and increasing the likelihood that work will be performed and increasing the quality of that work. While the component may be configured to block access all of the time, typically it is configured to block content during times in which task or subtasks are scheduled.

Blocking component 270 may be software programmed to block a user from performing certain operations with user computer 110. For the scheduling system illustrated in FIG. 2, the blocking component 270 is configurable, allowing the scheduling system to specify both the times at which blocking occurs and the activities that are blocked. For example, FIG. 2 illustrates that user computer 110 contains games and other software applications 260. While user computer 110 may be useful for performing assignments, games and other software applications 260 may present a source of distraction for a user. Accordingly, blocking component 270 may operate during scheduled study intervals to block execution of games and other software applications 260.

Similarly, web browser 250, which in the illustrated embodiment is a general purpose web browser, may enable a user to access websites that may contain distracting information unrelated to scheduled assignments. Accordingly, blocking component 270 may also block web content such that a user is less likely to be distracted through the use of web browser 250 to “surf the web” or engage in other functions unrelated to completion of assignments.

In the embodiment illustrated, blocking component 270 may be an executable module installed on user computer 110. Blocking component 270 may be downloaded from web server 130 or obtained from any other suitable source. To enable blocking, blocking component 270 may be loaded at boot time of user computer 110. Loading of blocking component 270 may be automatic, though exceptions may be provided. For example, the blocking component 270 may not be loaded if the user computer 110 is operating in safe mode.

Blocking component 270 may be any suitable component configured to selectively restrict execution of executable modules on user computer 110 and may operate in any suitable way. In the embodiment illustrated, blocking component 270 interacts with an operating system on user computer 110. Each time an executable is invoked, blocking component 270 interrupts the normal process of initiating execution of an executable module until the executable is checked against a “blacklist” maintained by blocking component 270. The data in this black list may be provided from any suitable source and may be configured by a user or a user with administrative privileges, such as a parent of a student who is the user for whom scheduling is provided.

In instances in which information on executables for the blacklist is provided by web server 130, the communication channel between the server 130 and user computer 110 may be encrypted. In this way, a user is precluded from interfering with the blocking function of blocking component 270 by altering the inputs to blocking component 270. For example, blocking component 270 may periodically catalog all executable files on user computer 110 and consult with a master list maintained on web server 130.

Regardless of how the blacklist is provided, if the executable is on the blacklist, execution is blocked. Information may be provided to the user indicating that a program has been blocked. For example, information may be presented in the form of a customizable message and/or image that displays the file and/or pathname of the executable for which execution was blocked.

Blocking component 270 may be implemented in a way that precludes a user from overriding the blocking. For example, the blacklist may be a list of names or executable modules as maintained by the file system of user computer 110. Whenever the blacklist is updated, blocking component 270 may scan the executable files existing on the user computer 110 to identify executables on the blacklist. Those files may then be hashed and the hash may be stored. Executables not on the blacklist may be periodically hashed to determine whether they match the hash of an executable on the blacklist. If the hashes match, blocking component 270 may conclude that a blocked application has been renamed. In this scenario, blocking component 270 may update the blacklist to include the renamed executable that was intended to be blocked. The blacklist may be periodically updated in this fashion, for example every 5 minutes, but the timing and manner of updates may be configurable or performed in any other suitable way.

In addition to blocking executable files, blocking component 270 may implement contingent web content blocking. As with blocking of executables, blocking of web content may be contingent on time, such that access to websites that could act as a distraction and prevent the timely completion of assignments can be blocked during scheduled study intervals. Web blocking may also be contingent upon subject matter. Subject matter for web content blocking, like the blacklist of executables, may be specified in any suitable way. For example, subject matter for blocking may be specified based on website or key words listed on websites. Additionally, content may be specified based on type of website, with the type being defined relative to catalogs of websites maintained on web server 130 or maintained by third parties or obtained in any other suitable fashion. Regardless of the contingencies under which web content is blocked, blocking component 270 may receive information defining the contingencies from application components within web-based application 210.

Blocking component 270 may operate in any suitable way to block access through user computer 110 to undesirable websites. Web blocking software is known and blocking component 270 may be implemented using technology as is known in the art for web content blocking. However, any suitable mechanism for web content blocking, whether now known hereinafter developed, may be employed to implement blocking component 270.

Regardless of how the components of the scheduling system are implemented, they may interact when operated to aid a user in establishing and complying with a plan for performing one or more tasks, which in the case of system to assist students may be school assignments. In operation, web-based application 210 may guide a user through the processes of establishing and complying with a plan. Interactions between web-based application 210 and the user may be through a series of graphical user interfaces, the content of which may be defined by the components of the web application executing on server 130.

FIG. 3 illustrates one such graphical user interface. The graphical user interface of FIG. 3 may be presented in a display window 310 on a display screen associated with user computer 110 or in any other suitable way. Window 310 may have panes, organized to present information in a desirable fashion. Additionally, window 310 may include one or more control objects configured to execute control functions when selected by a user and objects that display information. These objects may be implemented as COM objects that exchange information with a web-based application in server 130. Though user interfaces may be implemented in any suitable way.

Some of the control objects presented in window 310 may facilitate “navigating” so that a user may control the types of information displayed at one time. In the example illustrated, one of tabs 320A, 320B, 320C may be selected by a user to alter the types of information displayed. Tab 320A, when selected by a user, allows a user to manipulate information relating to tasks, which in the embodiment illustrated are school-related assignments. When tab 320B is selected, the scheduling system displays in window 310 information about scheduled tasks using a calendar format. When tab 320C is selected, window 310 displays information and controls allowing a user to configure settings that control the user's experience in interacting with the scheduling system. The settings may impact operation of user computer 110 or may be stored in association with account information in a database in a web-based application 210 and, therefore, impact operation of web-based application 210 on web server 130. For example, user 100 may register portable electronic devices with the assignment scheduling system to receive notifications. For example, user 100 may configure its account on server 130 with a telephone number for cell phone 140.

In the example of FIG. 3, a user has selected tab 320A. Accordingly, FIG. 3 provides an example of information that may be presented to a user for manipulating information relating to school assignments. The specific information displayed may be generated by a task entry component that forms a portion of the application code on web server 130.

Window 310 includes a pane 340 to provide a user with information about assignments that have been input into the scheduling system. In the embodiment illustrated, pane 340 lists assignments, classified by subject area. In the specific example illustrated in FIG. 3, three information blocks 344A, 344B, 344C are pictured in pane 340. Each information block 344A . . . 344C provides information on a previously defined assignment. Each information block may contain information useful for scheduling time to complete an assignment. For example, information block 344A contains information indicating that the type of assignment is “reading.” Additionally, an identifier for the assignment is included. In this example, information block 344A contains information about an assignment identified as “Grapes of Wrath.” Other information in the information block identifies the due date specified for the assignment and an estimate of the time required to complete the assignment.

In the embodiment illustrated, information blocks 344A . . . 344C do not expressly include an indication of the subject matter of the assignment. In the embodiment illustrated in FIG. 3, assignments are organized by subject matter. For example, information block 344A is associated with the subject “English” and information blocks 344B and 344C are associated with the subject header “Math.” However, it should be understood that the specific organization of information displayed in pane 340 is not a limitation of the invention and information about defined assignments may be presented in any suitable way.

Additionally, window 310 may allow a user to input information about assignments. The specific form in which information relating to entry of information about assignments is displayed is not critical to the invention. However, FIG. 3 provides an example of a suitable interface in which information about an assignment is entered in pane 330. In the embodiment illustrated, assignments are categorized by subject and each assignment may be assigned a type. For example, pane 330 is shown displaying an enumerated list of subjects that may be associated with an assignment being defined. Here, buttons 332A, 332B and 332C are provided to allow a user, through selection of a button, to specify a subject to be associated with the assignment. Button 332A, when selected, indicates the assignment being defined is for an English class, button 332B indicates the assignment is for a math class. Likewise, button 332C indicates the assignment is for a science class. Though three buttons are shown, any number of buttons may be provided, allowing a user to select between any number of subjects. The subjects displayed in pane 330 may be determined in any suitable way. For example, a scheduling system may include a number of predefined subjects, or subjects may be specified by a user such as through controls associated with settings tab 320C. However, the manner in which subjects are defined is not critical to the invention and any suitable mechanism may be used.

In the embodiment illustrated, window 310 is displayed on the display for a user computer 310. As is known in the art, a computer may contain a selection device, such as a mouse with a pointer that may interact through the operating system of the computer to allow a user to indicate a control object in a window and select that object through manipulation of the input device. In the example illustrated, the user has manipulated the input device to position a cursor (not numbered) above button 332A. User input, such as a mouse “click” with the cursor in this position indicates a selection. Such a point-and-click user interface is known in the art and in embodiments of the invention is used to provide user interfaces to the scheduling system. However, the specific mechanism by which user input is received through a window such as window 310, is not a limitation on the invention and any suitable mechanism may be used.

Pane 330 also shows buttons 334A, 334B and 334C that a user may select to specify a type of assignment about which information is to be entered. Button 334A indicates the assignment is a paper. Button 334B indicates the assignment is a test and button 334C indicates the assignment is reading. In the example shown, three assignment types are presented to a user, allowing the user to select one of the three types. However, the specific types and the specific number of types presented to a user is not a limitation of the invention. As with control objects allowing the user to specify a subject of an assignment, control objects allowing the user to select a type of assignment may be in the form of an enumerated list which may be preconfigured in the scheduling application or may be defined by a user through setting tab 320C or in any other suitable way.

In the embodiment illustrated, the scheduling system presents information and control objects to a user in a format that guides the user through actions associated with operation of the scheduling system. Accordingly, when a user completes an operation using information or controls displayed in a pane, the system may alter the pane to present information, controls or input requests related to a subsequent step in an operation. Accordingly, FIG. 3 shows that pane 330 includes a control 336 that a user may select to indicate that it has completed the step in the process of defining an assignment for which information is displayed in pane 330. When control object 336 is selected, the system may change the information in pane 330 to perform a next step in a process of defining an assignment.

Window 310 also may contain one or more control objects that allow a user to control the scheduling system to perform one or more functions. In the embodiment illustrated, window 310 is shown to contain a control object 350 that, when selected by a user, causes the scheduling system to update its calendar to reflect any changes to the assignments scheduled. In the embodiment illustrated, a plan for specific times during which work on assignments is computed by web-based application 210. Accordingly, activation of control object 350, similar to activation of other control objects, may result in information or commands being sent to server 130, which may trigger execution of components of web-based application 210.

Other control objects may perform other functions. As an example, window 310 is shown to have a control object 354. When the user selects control object 354, the scheduling system may toggle between a mode in which instructions are presented as the user interacts with control objects or other display areas in window 310, and a mode in which instructions are not provided.

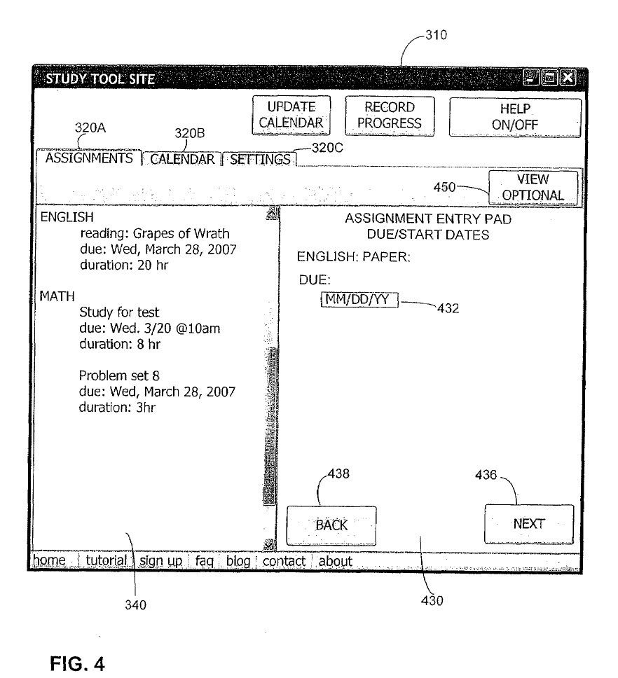

FIG. 4 shows window 310 configured for interaction with a user at a subsequent step in the process of defining an assignment. The display may appear as a result of user selecting control object 336 (FIG. 3). In the operating state illustrated in FIG. 4, a user has specified, through selection of control object 332A (FIG. 3) and control object 334A (FIG. 3) that the user is entering information about an assignment to complete an English paper. In the operating state depicted, pane 430 is configured to receive further information about the assignment. In this configuration, pane 430 has a control object 432, here configured as a text field, through which a user may input a due date for the assignment. Additionally, pane 430 includes navigation buttons 436 and 438. Similar to navigation button 336, navigation buttons 436 and 438 may change the pane displayed in window 310. In this scenario control objects 438 and 436, when selected, display a pane for a prior or subsequent step in a process, respectively. Accordingly, navigation button 436, when selected, will reconfigure window 310 to display a pane for a subsequent step in specifying information about an assignment. Conversely, navigation button 438, when selected, will replace pane 430 with a pane configured to interact with a user in a prior step in a process of specifying an assignment. In the configuration illustrated, selecting navigation button 438 will replace pane 430 with pane 330 (FIG. 3).

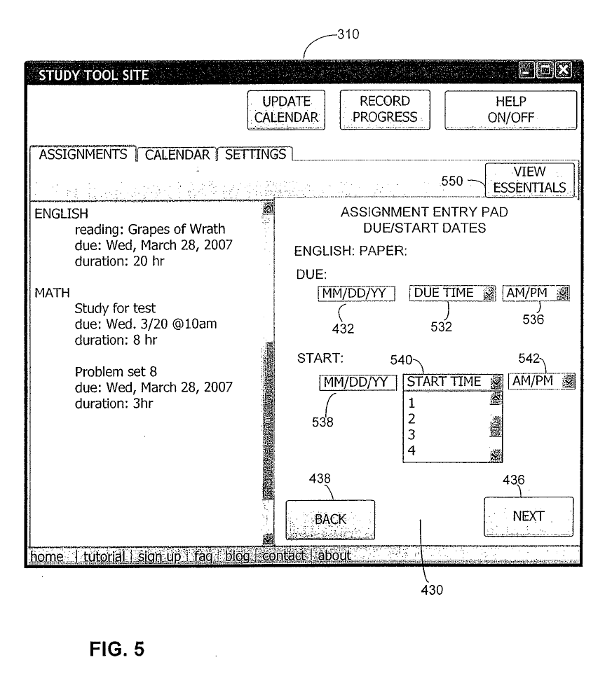

Any one or more control objects may be included to either alter the information presented in window 310 or to control functions performed by the scheduling system. In the example of FIG. 4, window 310 also includes a control object 450. When selected, control object 450 may cause the scheduling system to add optional information and control objects to pane 430. FIG. 5 illustrates an operating state in which control object 450 has been selected.

In FIG. 5, control object 450 has been replaced by a control object 550. When control object 550 is selected, the optional information presented in pane 430 is removed, reverting the display to the state shown in pane 430. As can be seen in the embodiment of FIG. 5, the optional information displayed includes additional control objects through which a user may specify both a time at which the assignment is due and a start time for the assignment. Accordingly, in addition to control object 432 through which a user may input a due date, pane 430 shown in FIG. 5 is configured with control objects 532 and 536 which allow a user to input a specific due time. As illustrated, control objects 532 and 536 are implemented as drop-down control objects. Control object 532, when accessed by a user, allows a user to select a time of day that the assignment is due. Control object 536, when selected by a user, allows a user to input whether the indicated time is in the morning or the afternoon. Information input through these control objects may be used by one or more components of web-based application 210. For example, a planning component may use this information to ensure that time for working on an assignment is planned so that the assignment is completed when due. A calendar component may use this information to more accurately display the due date.

Control objects 538, 540 and 542, allow a user to specify information relating to a start time. In this example, control object 538 is a text box through which a user may enter a start date. Control object 540 is a drop-down box through which a user may select a start time. In the example of FIG. 5, control object 540 is shown expanded, indicating that a user may select through control object 540 an appropriate start time. Control object 542, like control object 536, is a drop-down list box through which a user may specify whether the entered start time is in the morning or the afternoon.

The optional information specified through pane 430 may be used by a planning component to ensure that scheduled study time is allocated to perform the assignment specified. If a specific start date and start time is not specified, the planning component may treat the assignment as if the start time was specified as the present time. Likewise, if no specific time is specified in connection with the due date, the planning component may schedule time to complete the assignment assuming the assignment is due at the start of the due date. Accordingly, it is not necessary for operation of the scheduling system that the optional information be identified. If a user does not wish to view the fields through which such optional information can be identified, the user may select control object 550. If control object 550 is selected, pane 430 may revert to the operating state depicted in FIG. 4.

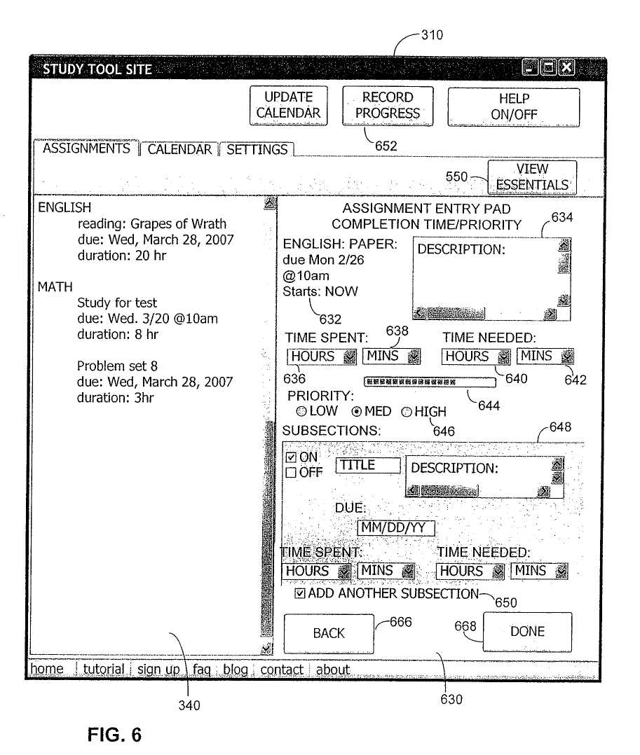

As noted above, pane 430 includes navigation buttons 436 and 438. Navigation button 436, when selected by a user, alters window 310 to replace pane 430 with a further pane containing information and control objects relating to further steps specifying an assignment. FIG. 6 shows pane 630 that may be displayed when navigation button 436 is selected from pane 430. In the example illustrated in FIG. 6, information block 632 presents information about the assignment for which information is being specified. In this example, information block 632 contains information entered through panes 330 and 430.

In pane 630, further information about an assignment may be specified through one or more control objects. This information may be used for planning or generating calendar views or other functions of the scheduling system. For example, control object 634 may be a text box through which a user may enter a description of the assignment, which may be used to display information about the assignment. Additionally, control objects may be included to allow a user to input information concerning the progress towards completion of the assignment which may be used to plan time for work on the assignment.

As an example of control objects through which a user may input information useful in tracking progress towards completion of the assignment control objects 636 and 638 are shown. In the specific example illustrated, control objects 636 and 638 are drop-down list boxes, which allow a user to input information concerning time spent towards completion of the assignment. Control objects 640 and 642 allow a user to specify an estimated time required for completion of a project. This information may be used to track progress towards completion of the assignment. In this example, progress bar 644 is used to indicate the progress towards completion of the assignment. The information may also be used by a planning component to ensure time is planned for completion of the assignment. For example, the difference between the time needed and the time spent represents time for which activity towards completion of the assignment should be scheduled. Control object 652, when selected, may transmit to web service 210 any progress information entered. In response, webservice 210 invoke one or more components that may update progress displays, prompt a user to request a rescheduling operation or otherwise use the information.

Other control objects in pane 630 may also be used to control the scheduling of an assignment. In this example, control object 646, here depicted as a series of radio buttons, may be used to specify a priority associated with the assignment. A planning component may use the priority assigned to applications to select an order in which assignments are scheduled. Additionally, the priority information may be used by the planning component in scenarios in which insufficient study time is available for scheduling assignments. Higher priority assignments may be given preferential scheduling.

The task component of the application may control processes that encourage the user to identify tasks and the total amount of time needed to complete a task. For example, this component may help the user break down larger tasks into subtasks and, in a piece by piece fashion, plan the total amount of work required. Information received as an input to this component may include the task and subtask names (e.g., task: “presentation,” subtasks: “research for presentation,” “outline of presentation,” “presentation practice”), task and/or subtask deadlines or due dates, and the lengths of time it will take to complete the task and/or subtasks. FIG. 6 contains an example of a user interface that may be provided.

In addition, pane 630 includes control objects that may guide a user through specifying tasks or subsections associated with an assignment. Work on each subsection may be planned in the same manner that work on an assignment may be planned. As shown, input area 648 contains control objects through which a user may input information about a subsection of an assignment. The information about a subsection may be the same as the information entered concerning an assignment. For example, input area 648 is shown with fields through which a user may enter a title or description of a subsection. Similarly, control objects allow a user to specify a due date for the subsection. Further, control objects may be included to allow a user to specify time needed for a subsection, as well as to provide progress information relating to time spent on the subsection.

Though pane 630 is shown with a single input area 648 for receiving information about one subsection, any number of display areas may be provided, allowing a user to break an assignment into any desired number of subsections. Accordingly, a control object 650 may be included to allow a user to indicate that an input area for a further subsection should be displayed. In this example, control object 650 is shown as a check box. When activated in this way, the scheduling system may guide the user through the specification of assignments and breaking each assignment into subsections that may be more readily scheduled an tracked.

In pane 630, navigation buttons 666 and 668 are shown. As in pane 430, navigation button 666 may cause the pane 630 to be replaced by a pane presenting control objects for a prior step in the assignments specification process. Navigation button 668, when selected by a user, enters the assignment into the assignment list, which appears in pane 340 and may return window 310 to the state depicted in FIG. 3. Upon entry of the assignment into the assignment list, the task entry component may record the assignment in a database where it may be operated on by other components of the scheduling system.

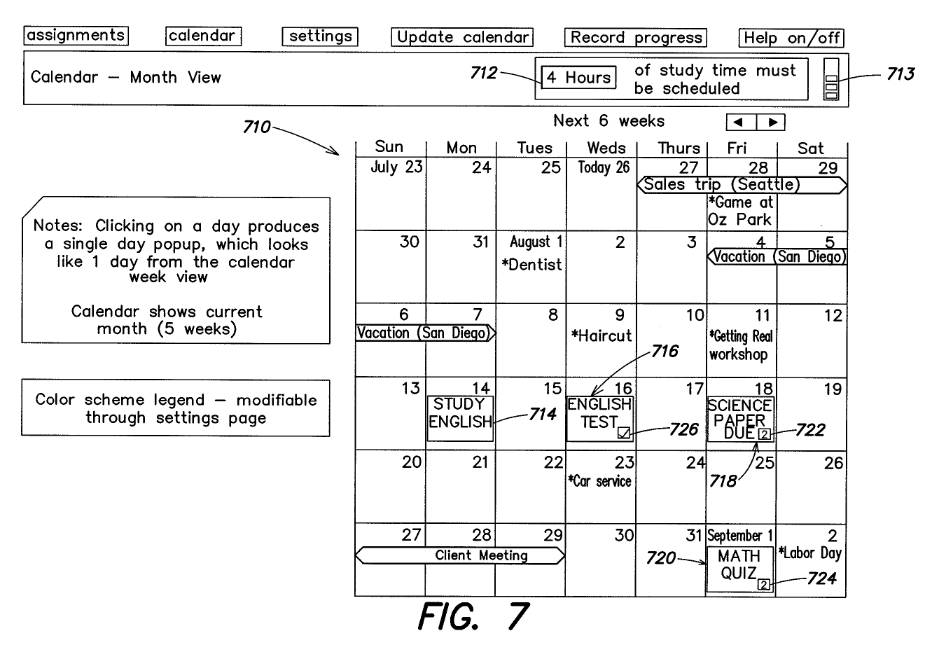

The information input through panes 330, 430 and 630 may be used by the task entry component of the web-based application 210 (FIG. 2) and the task updating component. These components may maintain information concerning a user's schedule in a database associated with web server 130. Other components of the scheduling system may operate on the data to present a schedule for a user. FIG. 7 illustrates a calendar component that may operate on data stored for a user.

The calendar component may provide typical software calendar elements such as the ability to have multiple views, such as a “day” view and a “week” view, the ability to schedule calendar events, and the like. In addition, scheduling component includes the functionality to specify blocks of time set aside for completing tasks and/or subtasks generally, such as setting aside Friday mornings into which tasks and/or subtasks can be scheduled.

The calendar component may control processes that encourage a user to place tasks and subtasks on the calendar and generates a task calendar showing for each task and subtask, during what block of time to work on what, and for how long (e.g., “Thursday 1/18, 6-8 p.m. presentation practice”). Of course, if such a task completion schedule is impossible to create based on the user's input, the application informs the user. The application also may reschedule based on new user input. If the user completes or fails to complete tasks or subtasks, or adds new tasks and/or subtasks to the task list, the application can be prompted to produce a new task schedule.

FIG. 7 uses a “wire frame” format to represent a user interface that may be provided by the calendar component. FIGS. 3, 4, 5 and 6 depict a window, such as may appear in a windows-based graphical user interface. The control objects may be COM objects supported by the Windows® operating system. Those figures provide one example of how such controls could appear to a user. However, the specific implementation of control objects is not critical to the invention. In contrast, FIG. 7 illustrates a “wire frame” representation of a user interface to the scheduling system in alternative operating states. The user interface depicted in FIG. 7 may include control objects that perform functions similar to those illustrated in connection with FIGS. 3-6, but the control objects are illustrated schematically. For example, an “assignments” tab, a “calendar” tab, and a “settings” tab are shown schematically, though those tabs do not appear as they may on a user interface. Similarly, control objects to update a calendar, record progress and toggle the help settings are shown. These control objects may be implemented and depicted in the same way as tabs 320A . . . 320C and control objects 350, 352, 354, respectively. Accordingly, FIG. 7 could illustrate a window 310 when the calendar tab 320B is selected. However, because the specific format of the user interface is not critical to the invention, FIG. 7 shows schematic representations of objects that may appear on a user interface.

In the calendar view as illustrated in FIG. 7, a pane 710 is shown containing a calendar in graphical form. In this example, the calendar is shown picturing six weeks.

The calendar presented in pane 710 may depict scheduled activities similar to known computerized calendaring systems. Accordingly, trips and other events may be indicated on the calendar depicted in calendar pane 710. Additionally, the calendar may be adapted to assist in the scheduling and performance of assignments. Using information stored in a database on web server 130, a calendar component may indicate to a user due dates for assignments and subsections of assignments. Additionally, the calendar pane 710 may indicate study time allocated by the user and may present to the user a schedule of assignments or subsections of assignments on which a user should work in designated study times. The study times and scheduled activities in those study times may be allocated in any suitable way. For example, study time may be indicated by blocks of a different color and activity within a study time may be indicated by text.

Accordingly, FIG. 7 shows a block 714 indicating study time has been allocated on the 14^{th} of the month. Block 714 contains text indicating to the user that studying English has been planned for the designated study time. Indications 716, 718 and 720 are also shown, indicating due dates or end points for tasks or assignments. In the embodiment illustrated, indication 716 indicates a planned English test, which may be the end point of tasks relating to studying for the test. Indication 718 indicates a planned due date for a science paper, which is the end point for any tasks relating the writing that paper. Likewise, block 720 indicates a planned math quiz, which is the end point for tasks relating to studying for that quiz.

Information may be presented in calendar pane 710 in any suitable format. For example, FIG. 7 illustrates fields that may aid a user schedule an appropriate amount of study time. The calendar may incorporate additional functionality that relates to tracking how much study time remains to be scheduled and by when. As shown, a field may be displayed in conjunction with the calendar, indicating the total amount of additional study time that needs to be scheduled so that all assignments may be completed. The value displayed in the field may decrement appropriately as additional study time is scheduled. The value may increase or decrease as information about tasks to be complete is changed, indicating that more or less study time is required.

Field 712 illustrates an example of such a field in which the required study time is communicated using text. However, the form in which information is presented to a user is not critical to the invention and any suitable representation may be used instead of or in addition to a text field. As an example, FIG. 7 illustrates a progress bar 713, which provides information graphically about additional study time required to complete currently identified tasks. Progress bar 713 may display any suitable information, such as the number of hours required to be scheduled. Alternatively, progress bar 713 may display the percentage of required study time that has been scheduled.

A need for additional study time to complete identified assignments may alternatively or additionally be displayed in other ways. In the embodiment illustrated in FIG. 7, each block identifying the end point of a task may include an indicator of the amount of additional study time for which work on that task would have to be planned to provide the amount of study time required for that task. Accordingly, FIG. 7 shows fields 722 and 724 associated with blocks 718 and 720, respectively. Each of fields 722 and 724 contains a text value, indicating the difference between an identified amount of time to complete the task represented by the associated blocks and the time that has been planned for that task.

In some embodiments, the information displayed in field 712 may be the sum of the values shown in each block associated with a task end point. However, information about additional study time required to complete identified assignments may be indicated in any suitable way.

If sufficient study time has been planned for a task, that information may also be indicated through a user interface. For example, block 716 contains a field 726. Rather than indicating a number of hours of studying to be completed, this field contains a symbol indicating that sufficient study time has been scheduled. In the embodiment illustrated, the symbol is a check mark, but any suitable format for representing that information may be used.

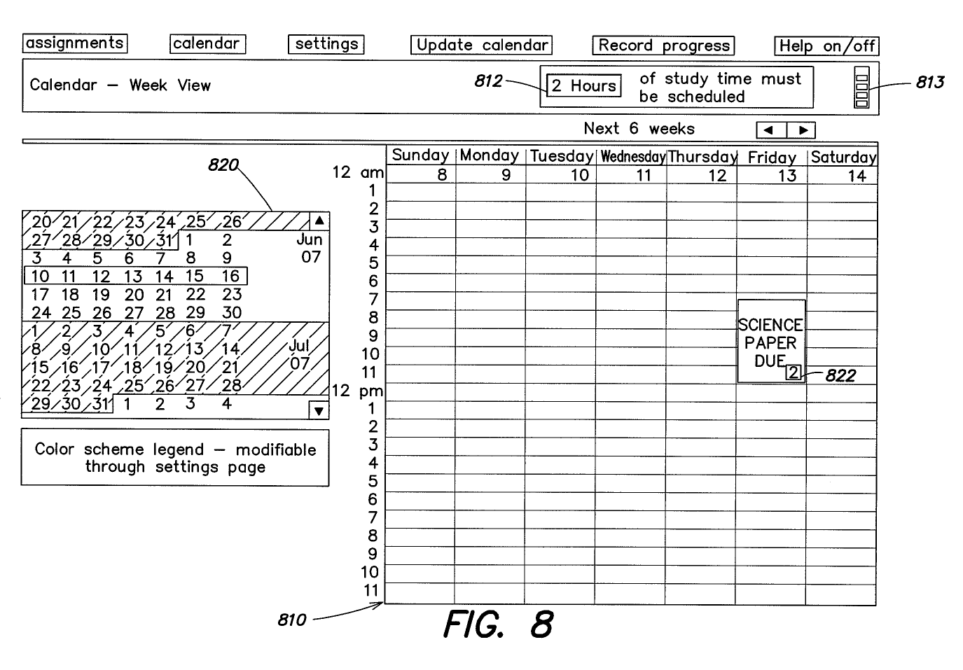

The scheduling system may provide functions that facilitate use of a calendar in graphical form. For example, each of the days depicted in the calendar in calendar pane 710 may be a control object. Selecting these objects may alter the view presented in calendar pane 710. For example, selecting a week may change the display to that pictured in FIG. 8.

In the embodiment illustrated in FIG. 8, calendar pane 810 may present graphically one week of schedule information. A control object 820 may be included to allow a user to identify the specific week selected. The same types of information may be displayed in the one-week view as are displayed in the six-week view of FIG. 7. For example, blocks of study time and due dates may be indicated.

In the embodiment illustrated, the calendar functions may be similar to those provided by known calendar applications. However, in the specific embodiment illustrated, rather than scheduling only events or activities, a user may also schedule study time. A planning component of the scheduling system may then match assignments with the scheduled study time. To aid a user scheduling study time, the embodiments depicted in FIGS. 7 and 8 show an output field on the graphical user interface. Field 712 provides information to aid the user in identifying an amount of study time that a user should schedule in order to provide sufficient time for scheduling all identified assignments. The information in text fields 712 may be computed based on the format of the display. For example, in FIG. 7, calendar pane 710 displays a six week interval. Accordingly, in the configuration depicted in FIG. 7, text field 712 indicates the amount of study time required for scheduling over the next six weeks.

In contrast, FIG. 8 shows a calendar pane 810 in which a one-week interval is depicted. During that week, in the example shown, a science paper is due for which an additional two hours of study time is required. Accordingly, in this operating state, text field 812 displays a value indicating the number of hours of study time that should be scheduled in that week to complete all identified assignments, which in this example is two hours.

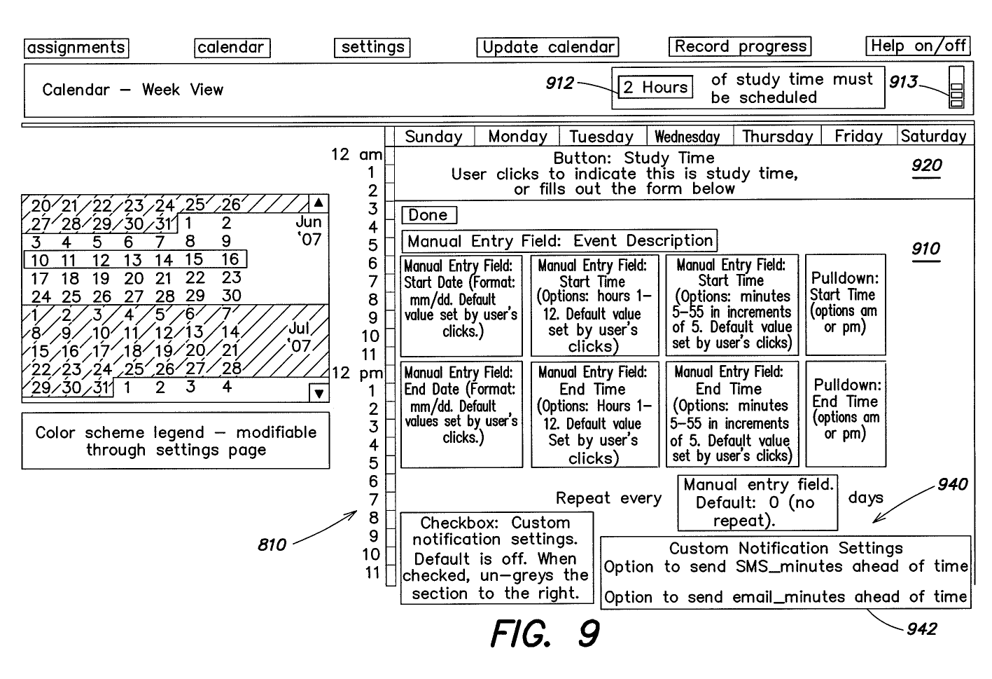

FIG. 9 shows an alternative operating state of the user interface of FIG. 8. In the operating state depicted in FIG. 9, a dialog box 910 is shown overlaid on the calendar pane 810. Through dialogue box 910, a user may schedule study time. The user may access dialogue box 910 by selecting an interval of time on the calendar as depicted in window 810.

Dialogue box 910 is shown with a control object 920, here a button object, that a user may select to designate that the selected interval is to be set aside as study time. In the embodiment illustrated, if a user specifies that time is designated as study time, the planning component of the scheduling system may schedule assignments to be performed during that study time interval. For example, in response to a user selecting update calendar control object 350, the planning component may plan work on assignments by allocating scheduled study time to assignments and subcomponents of assignments. Any suitable algorithm may be used by the planning component to allocate study time to specific assignments. As one example of a suitable algorithm, the planning component may allocate study time to assignments in due date order. Assignments with earlier due dates will be assigned study time first. In the event that the planning component cannot allocate available study time to complete all assignments, it will first allocate study time to the highest priority assignments. In some embodiment, user preferences may also be considered in allocating assignments to available study time. For example, through the settings tab 320C, a user may indicate a preference for limiting study time on any given assignment to blocks to time that do not exceed a specified maximum duration.

Regardless of how blocks of study time are allocated to the assignments, once assignments are scheduled, they may be displayed graphically to the user, as in field 714 (FIG. 7). Additionally, the information concerning the schedule may be stored in a database on web server 130 and other components of the web-based application 210 may access that information to perform other functions. For example, the notification component may access the schedule of assignments and send notifications to a user to start and/or stop assignments at their scheduled times. Additionally, blocking component 270 may similarly access the schedule and block applications or web access during scheduled study intervals. In some embodiments, blocking component 270 may operate only during scheduled study intervals in which assignments have been scheduled. However, in some embodiments, blocking component 270 may operate during all scheduled study times, regardless of whether assignments have been scheduled for those times.

The planning component may be triggered to operate at any suitable times. For example, when a user completes entry of an assignment, the user may activate the update calendar control object 350, causing the planning component to repeat it's scheduling algorithm based on the current list of assignments. Additionally, following entry of progress information, such as through pane 630, a user may activate the record progress control object 652. When activated, information identifying the amount of time needed to complete one or more assignments may change. Accordingly, the planning component may again execute to schedule the required time to complete all assignments in the assignment list.

The calendaring functions supported by the scheduling system may also be used to record events other than assignments. In the example of FIG. 9, dialogue box 910 includes an input area 940 that may be used to schedule events similar to the way events are scheduled in a conventional calendar system. For example, input area 940 includes fields through which a user may enter a description of an event and fields through which a user may specify start and stop times for the events. Additionally, the input area 940 may control a control object 942 through which a user may specify that it should receive a notification at the scheduled time of the event. Such information may be recorded and accessed by the notification component.

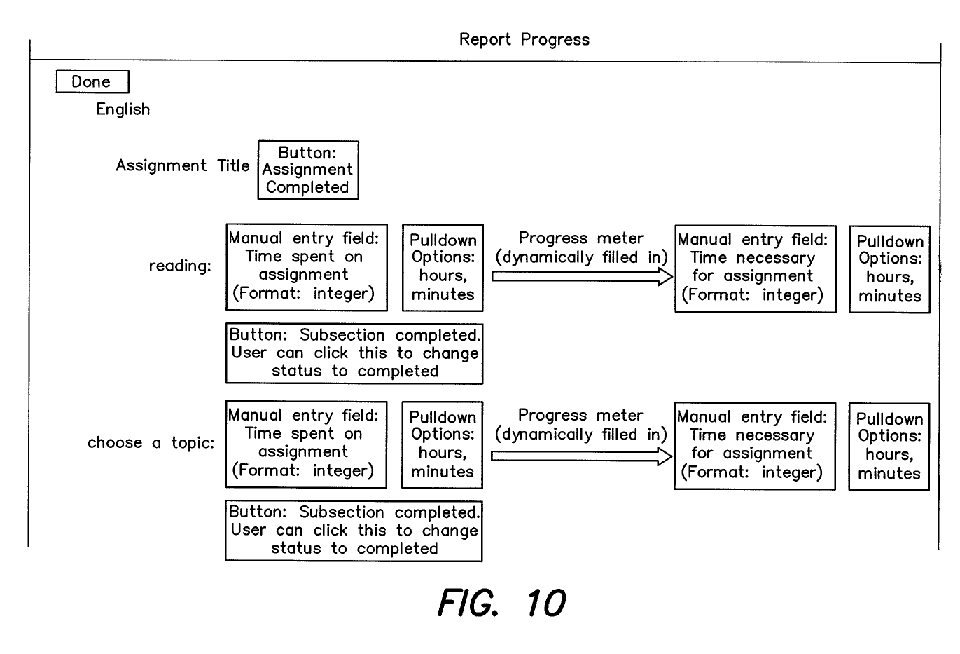

It should be appreciated that the graphical user interfaces depicted serve as examples only of interfaces that may be used to interact with the user in a scheduling system according to embodiments of the invention. For example, FIG. 6 shows control objects through which a user may input information concerning progress on an assignment. FIG. 10 shows an alternative embodiment of a user interface through which the user may input progress concerning an assignment. The graphical user interface depicted in FIG. 10 may be invoked in any suitable way, such as in response to user activation of a control object, such as control object 652 (FIG. 6). As shown, the user interface may include control objects to allow a user to update time spent on an assignment or an estimate of time necessary to complete and assignment. Additionally, control objects in the interface of FIG. 10 may be used to indicate that the assignment has been completed.

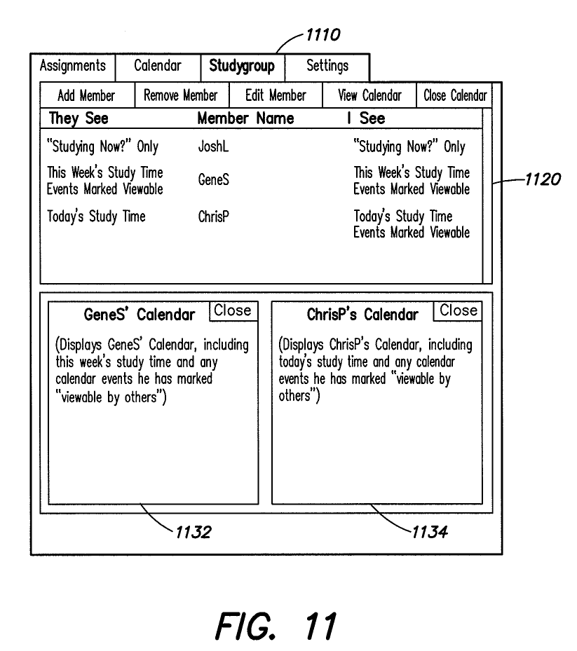

As described above, the scheduling system may support functions of known calendaring systems. As one example, the scheduling system may allow users to share their schedules with other users. In some embodiments, the system may support study groups. As shown in FIG. 11, a study group tab 1110 has been selected. Selecting study group tab 1110 invokes an interface through which a user may perform functions relating to a study group containing multiple users of the scheduling system. As illustrated by the control objects available to the graphical user interface depicted in FIG. 11, the study group feature allows users to view each other's study schedules. A user may create a study group and can assign other users of the scheduling system to the study group. A user establishing a study group may administer the study group, such as by assigning other numbers and granting the members levels of access. Levels of access may include view only access. A user with view only access can view only whether or not another user is currently scheduled to be studying. Alternatively, a user may be granted access to information about the time another user in the study group has scheduled for studying during the current day. As a third possibility, a user may be granted access to view the time that other users in the study group have scheduled for study during the current week. An even higher level of access may be provided, allowing users to see all events scheduled for other users in the study group that are marked “viewable” by those users.

As a way to reduce distractions, the study group features may be unavailable to a user during their own study time.

As illustrated in FIG. 11, information about other members in the study group may be presented to a user through one or more panes. Pane 1120 may display information, to the extent the user is permitted by that user's access level, to view that information. Window 1120 may list each member of the study group, and using color coding or other suitable indications, indicate which users are currently studying. Those that are not studying, for example, may be presented in green text. Those that are studying, may be listed in red text.

Panes 1132 and 1134 may present different types of information. These panes may present schedule information about individual users, to the extent that the user accessing the system through the interface depicted in FIG. 11 is authorized to access that information. For example, calendar information concerning users in the study group may be accessed by clicking on the name of the user in pane 1120.

While the invention is discussed with regard to the specific example of a web application, it is understood that the invention includes other embodiments such as on a handheld device. The method may be implemented in a computer environment having software, hardware or the like. The software may include source code, object code executable code, or the like and may be platform specific (e.g., for Windows), platform independent (e.g., Java). The hardware may be dedicated or multi-purpose and include CPUs, input devices, output devices, storage, memory and the like. The computer environment may be localized (e.g., on a single computer), networked (e.g., on a LAN), a client server arrangement, or as part of the Internet.

Having thus described several aspects of at least one embodiment of this invention, it is to be appreciated that various alterations, modifications, and improvements will readily occur to those skilled in the art.

Embodiments of a scheduling system adapted for students needing to schedule tasks associated with school work has been described. However, the invention, in some embodiments, may be useful in other context, such as scheduling construction projects or other activities.

Also, multiple features of a system have been described. Embodiments may be constructed using only a subset of the full feature set described. For example, a system planning specific tasks for specific blocks of time was described. Notification and blocking functions aid a student to execute tasks as planned, such as by providing a student with a notification in advance of these blocks of time or blocking distractors during those blocks of time. The notification and blocking functions may operate without scheduling specific tasks in blocks of time. Accordingly, some embodiments may support a mode of operation in which a user schedules work time and receives notifications of that time. Distractors may also be blocked during that time. Such alterations, modifications, and improvements are intended to be part of this disclosure, and are intended to be within the spirit and scope of the invention. Accordingly, the foregoing description and drawings are by way of example only.

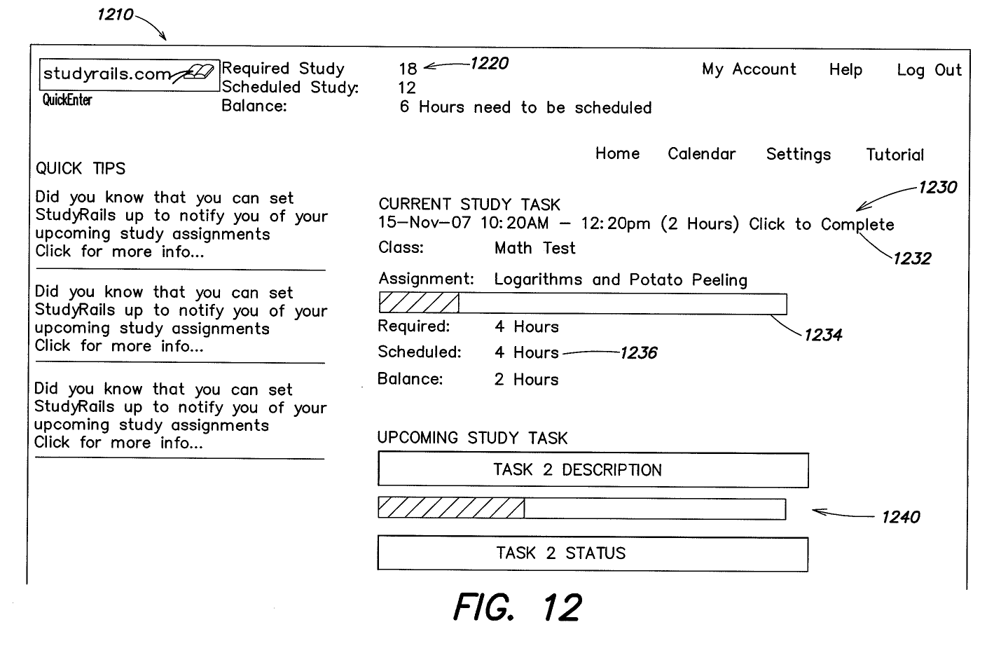

As another example, other user interfaces to the planning system may be constructed to arrange information in a format useful to a student planning school work assignments. FIG. 12 illustrates an example of a user interface that may be presented as a welcome screen to a user logging on to a server hosting the student assignment planning system. FIG. 12 illustrates a user interface 1210 that may contain multiple display areas depicting information useful to a student planning and executing assignments.

In this embodiment, user interface 1210 includes a scheduled work time status area 1210. Status area 1210 may provide text, or information in any other suitable format, informing a user on the amount of study time scheduled or the amount of additional study time that needs to be scheduled. In the example of FIG. 12, status area 1220 provides the user with an indication of the required amount of study time that would be required to complete all upcoming tasks according to estimates of required study time provided in conjunction with each of the tasks.

The required study time may be computed over any suitable interval. For example, the aggregate number presented in status area 1220 may represent the sum of estimated study time for all tasks scheduled within the next week, within the next month or within any other suitable interval or may represent an aggregate for all tasks input to the planning system. However, any suitable mechanism may be used for determining which tasks to consider in aggregating a current required study time.

In addition, scheduled study time status area 1220 may indicate an amount of study time scheduled in which work against upcoming tasks has already been planned. Additionally, status area 1220 may include an indication of the balance of study time that needs to be additionally scheduled in order to plan the amount of study time estimated for all of the upcoming tasks.

Additionally, a graphical user interface 1210 may include one or more task status areas. Task status area 1230, for example, may present information about a task which a user should be currently performing or the next planned study task. Status area 1240 may provide information about an upcoming study task, such as the study task planned for the next study interval following the study interval for which a task is described in status area 1230.

In the example illustrated, each of the task status areas, such as task status area 1230, may include fields providing different types of information. In FIG. 12, task status area 1230 includes a task description field 1232, a graphical progress indicator 1234 and a scheduled study time status field 1236. Task description field 1232 may contain a description of the task, indicating to a user what actions are required to complete the task and when those actions are planned or due.

Progress indicator 1234 may indicate one or more status conditions relating to the task. In this example, progress indicator 1234 is a graphical indicator showing progress towards completion of the task. Here, status indicator 1234 has a shaded portion with a size relative to the overall size of the progress indicator indicative of the percentage of the task that has been completed. However, any suitable mechanism may be used to indicate progress, and the progress may indicate completion of the task or other suitable metric. For example, a progress indicator alternatively or additionally may present information on the percentage of required study time planned for the task or other suitable metric.

Study time scheduling status field 1236 may contain information relating to estimated study time for the task depicted in task status area 1230. The information in status field 1236 may be in the same form as in status area 1220. However, in the embodiment illustrated, the information in status field 1236 relates only to estimated and scheduled time for the task depicted in task status area 1230 while information in status area 1220 relates to all identified tasks in the aggregate.

Task status area 1240 may contain information similar to that in task status area 1230. In this case, task status area 1240 provides information on a second task. In this example, information is presented on tasks in the order in which time for work on those tasks is planned. Accordingly, information may be presented in any suitable number of upcoming tasks through graphical user interface 1210.

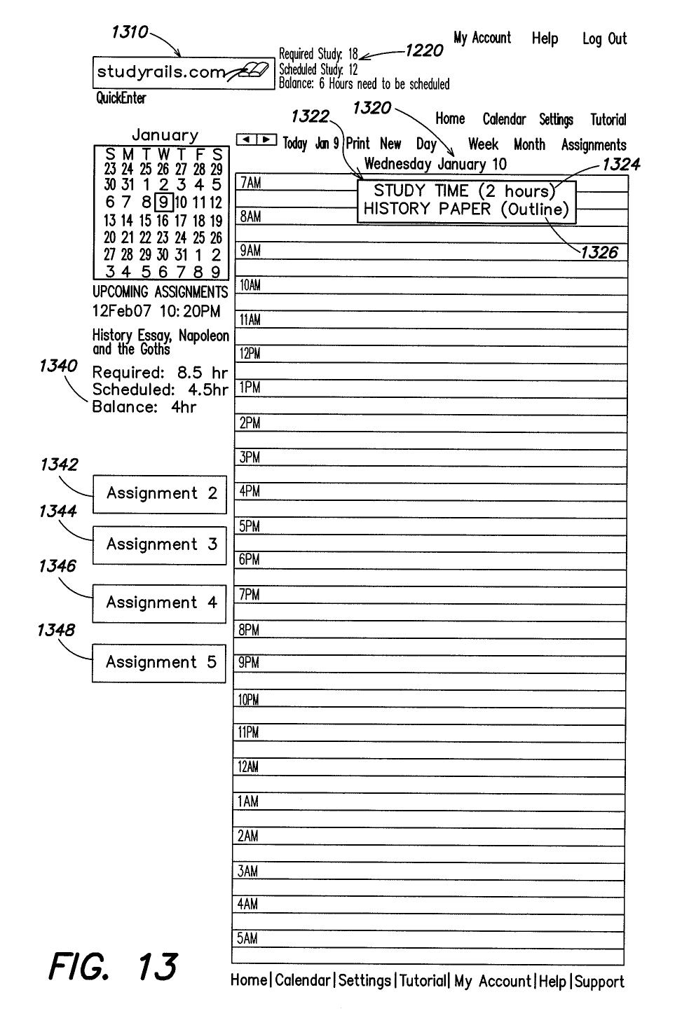

FIG. 13 illustrates an alternative embodiment of a user interface through which a planning system may provide information to a user about planned tasks. FIG. 13 illustrates graphical user interface 1310. User interface 1310 may include components as are in other user interfaces. For example, a scheduled study time status area1220, as illustrated in FIG. 12, may also be included in user interface 1310.

In this case, user interface 1310 presents information about upcoming planned tasks in a calendar display area 1320. In this example, display area 1320 presents a single day in calendar format. The day represented in calendar display area 1320 may be a current day or may be selected by a user manipulating control objects in graphical user interface 1310 or any other suitable way.

In this example, calendar display area 1320 indicates that a study task has been planned for performance during an interval in the day displayed in calendar display area 1320. In this example, a graphical indicator, such as box 1322, indicates planned study time. Information within box 1322 identifies for a user actions planned for execution during the indicated study time. In this example, text 1324 indicates that two hours of study time have been dedicated to performing a task indicated by text 1326. In this example, text 1326 indicates that the planned task relates to writing a history paper. A specific sub task of preparing an outline for the history paper is planned for the indicated interval. However, any suitable task or subtask may be planned for the identified interval and this information may be communicated to a user in any suitable way.

In addition, other types of information may be presented through graphical user interface 1310. In this example, information about upcoming assignments is presented through status fields 1340, 1342, 1344, 1346 and 1348. Each such status field may provide information about an upcoming assignment. In this example, each of the assignment fields may provide a user with information about the assignment due date and additional study time that must be scheduled in order to provide adequate time for planning execution of all tasks associated with that assignment. However, any suitable information may be presented relating to assignments and their status.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer-readable medium having a plurality of computer-executable components comprising:
a task list component for obtaining from a user information relating to a task, the information comprising at least a task due date;
a user interface component for obtaining from a user an indication of available work time;
a planning component for automatically planning work on the task during the available work time; and
a reminder component for providing a cue to the user of the planned available work time for the task.

2. The computer-readable medium of claim 1, wherein the task list component comprises a graphical user interface adapted to receive information relating to a school assignment.

3. The computer-readable medium of claim 2, wherein the task list component further comprises a graphical user interface adapted to receive information relating to a plurality of subtasks in completing the school assignment.

4. The computer-readable medium of claim 1, wherein the task list component comprises an interface to an SMS system, the interface being adapted to receive an identification of a task sent through an SMS message.

5. The computer-readable medium of claim 1, wherein the reminder component comprises an interface to an SMS system, the interface being adapted to send a reminder of a start of the planned work time for a task through an SMS message.

6. The computer-readable medium of claim 1, further comprising a blocking component, the blocking component comprising a blocking interface to a component on a client electronic device, the blocking interface conveying information identifying a planned work time during which a function of the client electronic device is to be blocked.

7. The computer-readable medium of claim 6, wherein the blocking interface conveys information identifying functions of the client electronic device to be blocked.

8. A method of scheduling tasks, comprising:
receiving through a user interface to a computing system user input defining available work time;
receiving through a user interface to the computing system user input defining tasks and estimated work time for each task;
receiving a plan for work on the tasks within the available work time; and
presenting through a user interface of the computing system a representation of a calendar indicating the plan for work on the tasks.

9. The method of claim 8, further comprising providing through an interface to the computing system a cue of a task to perform during the defined work time.

10. The method of claim 8, wherein:
receiving the user input defining available work time comprises receiving user input through a user interface on a client computer;
receiving the user input defining tasks and estimated work time for each task comprises receiving user input through the user interface on the client computer; and
receiving the plan for work on the tasks comprises receiving the plan from a server.

11. The method of claim 10, further comprising computing on the server the plan for work time.

12. The method of claim 8, further comprising presenting an indication through a user interface to a computing system of a difference between defined available work time and an aggregate estimated work time for the defined tasks.

13. The method of claim 12, wherein:
presenting the representation of the calendar comprises presenting a calendar interval; and
presenting the indication of the difference comprises presenting a difference between defined available work time and an aggregate estimated work time for the defined tasks during the calendar interval.

14. The method of claim 13, further comprising:
altering the calendar interval in response to user input; and
altering the indication of the difference based on the altered calendar interval.

15. The method of claim 8, further comprising, in conjunction with presenting through the user interface a representation of a calendar, presenting a graphical indication of additional available work time required to plan work time equaling the estimated work time for each of a plurality of tasks.

16. The method of claim 15, additionally comprising:
receiving user input indicating progress toward completion of a task;
updating the estimated work time for the task in response to the user input indicating progress; and
updating the graphical indication of additional available work time in response to the updated estimated work time.

17. The method of claim 8, further comprising
receiving through the user interface input defining user preferences in scheduling tasks; and
preparing the schedule in accordance with the user defined preferences.

18. The method of claim 17, wherein receiving user input defining tasks and estimated work time for each task comprises receiving an end date and a priority.

19. The method of claim 8, wherein receiving user input defining tasks and estimated work time for each task comprises receiving user input defining a plurality of subtasks associated with a task.

20. A computer-implemented method of improving student homework assignment planning and follow through, the method comprising:
receiving at a computer an identification of one or more tasks to be completed by a user;
scheduling, in the computer, work time for the one or more tasks; and
selectively blocking access to software or hardware during scheduled work time for the one or more tasks.

21. The method of claim 20, further comprising:
electronically reminding a user of a start time of each of the one or more tasks.

22. The method of claim 21, wherein selectively blocking access to software or hardware comprises blocking access to instant messaging software.

23. The method of claim 21, wherein selectively blocking access to software or hardware comprises blocking access to selected web sites.

24. The method of claim 23, wherein receiving the identification of one or more tasks to be completed comprises presenting to the user successive user interface screens adapted to receive a definition of a task and a plurality of subtasks within the task.
